(19) United States
(12) Patent Application Publication
(10) Pub. No.: US 2017/0195273 A1
(43) Pub. Date: Jul. 6, 2017

(54) ELECTRONIC MESSAGE DELETION SYSTEM

(71) Applicants: Peter A. Schultheiss, Scottsdale, AZ (US); Michael A. Mills, Lost Angeles, CA (US); Dhruva Ganesan, Brooklyn, NY (US); David E. Mills, Cleveland, OH (US)

(72) Inventors: Peter A. Schultheiss, Scottsdale, AZ (US); Michael A. Mills, Lost Angeles, CA (US); Dhruva Ganesan, Brooklyn, NY (US); David E. Mills, Cleveland, OH (US)

(21) Appl. No.: 14/985,747

(22) Filed: Dec. 31, 2015

(51) Int. Cl. H04L 12/58; G06F 3/16; G06T 13/80; G06F 3/0482; G06F 3/0488

(52) U.S. Cl. CPC H04L 51/22; G06F 3/0482; G06F 3/04883; G06T 13/80; G06F 3/167

(57) ABSTRACT

A method comprises the steps of determining that at least one message of a set of electronically formatted messages previously received by and stored in a memory of an electronic computing device was selected for removal from the electronic computing device; determining that a removal command associated with the message input into the electronic computing device through a user interface of the electronic computing device; graphically depicting destruction of the message by presenting a destruction animation on a visual human-computer interface; and removing the message from the set of electronically formatted messages.

### TECHNICAL FIELD

The apparatuses and processes described below relate generally to the field of electronic messaging and specifically to apparatuses and processes for managing retention and deletion of electronic messages.

### BRIEF DESCRIPTION OF THE DRAWINGS

FIG. 1 is a system block diagram of an electronic messaging system.

FIG. 2 is a system block diagram of an electronic messaging client.

FIG. 3 is a flow diagram of a process for deleting electronic messages.

FIGS. 4A-4E are plan views of a user interface for deletion of electronic messages.

FIGS. 5A-5D are plan views of a user interface for quick deletion of electronic messages.

FIGS. 6A-6E are plan views of a user interface for batch deletion of multiple electronic messages.

FIG. 7A is a plan view of an optical storage device.

FIG. 7B is a plan view of a non-volatile memory chip.

FIG. 7C is a perspective view of a non-volatile storage device.

FIG. 7D is a perspective view of a hard disk drive.

FIG. 8 is a plan view of a mobile communication and computing device.

### SUMMARY

A method comprises the steps of determining that at least one message of a set of electronically formatted messages previously received by and stored in a memory of an electronic computing device was selected for removal from the electronic computing device; determining that a removal command associated with the message was input into the electronic computing device through a user interface of the electronic computing device; graphically depicting destruction of the message by presenting a destruction animation on a visual human-computer interface; and removing the message from the set of electronically formatted messages. The step of graphically depicting destruction of the message can comprise the step of optionally playing sound through a speaker of the electronic computing device.

The destruction animation can be an animation selected from the group consisting of a cartoon, a cartoon with accompanying sound, a computer-generated moving image, a computer-generated moving image with accompanying sound, a movie, and a movie with accompanying sound.

The electronic computing device can be a mobile communication and computing device and the visual human-computer interface can be a touch-sensitive display screen. The message can be a message selected from the group consisting of an electronic mail message, a short message service (SMS) message, and a multimedia messaging service (MMS) message. Other suitable electronic file formats can also be used. The removal command can be activated by one of a selection of a button on the touch-sensitive display screen and a gesture made on a surface of the touch-sensitive display screen.

The removal command can be an archive command and the step of removing the message from the set of electronically formatted messages can comprise archiving the message. The removal command can be a deletion command and the step of removing the message from the set of electronically formatted messages can comprise the step of deleting the message.

The step of deleting the message can comprise the step of securely deleting the message to prevent recovery of the message. The method can further comprise the step of sending a second deletion command from the mobile communication and computing device to a message server to instruct the message server to delete a copy of the message stored on the message server. The second deletion command can be formatted to instruct the message server to securely delete the copy of the message stored on the message server to prevent recovery of the copy of the message stored on the message server.

A non-volatile computer-readable medium can include computer-interpretable instructions encoded to instruct an electronic computing device to perform steps in a method. The method comprises the steps of determining that at least one message of a set of electronically formatted messages previously received by and stored in a memory of an electronic computing device was selected for removal from the electronic computing devices; determining that a removal command associated with the message was input into the electronic computing device through a user interface of the electronic computing device; graphically depicting destruction of the message by presenting a destruction animation on a visual human-computer interface; and removing the message from the set of electronically formatted messages. The step of graphically depicting destruction of the message can comprise the step of optionally playing sound through a speaker of the electronic computing device.

The destruction animation can be an animation selected from the group consisting of a cartoon, a cartoon with accompanying sound, a computer-generated moving image, a computer-generated moving image with accompanying sound, a movie, and a movie with accompanying sound.

The electronic computing device can be a mobile communication and computing device and the visual human-computer interface can be a touch-sensitive display screen. The message can be a message selected from the group consisting of an electronic mail message, a short message service (SMS) message, and a multimedia messaging service (MMS) message. The removal command can be activated by one of a selection of a button on the touch-sensitive display screen and a gesture made on a surface of the touch-sensitive display screen.

The removal command can be an archive command and the step of removing the message from the set of electronically formatted messages can comprise archiving the message. The removal command can be a deletion command and the step of removing the message from the set of electronically formatted messages can comprise the step of deleting the message.

The step of deleting the message can comprise the step of securely deleting the message to prevent recovery of the message. The method can further comprise the step of sending a second deletion command from the mobile communication and computing device to a message server to instruct the message server to delete a copy of the message stored on the message server. The second deletion command can be formatted to instruct the message server to securely delete the copy of the message stored on the message server to prevent recovery of the copy of the message stored on the message server.

An apparatus comprises a message management module in data communication with a message data store of an electronic computing device that is capable of receiving an electronic message; and animation rendering module in data communication with an animation data store of the electronic computing device; and a command input/output module in data communication with the message management module and the animation rendering module, and configured to accept a removal command signal input through a user interface of the electronic computing device; wherein, in response to a removal command signal, the animation rendering module graphically depicts on a visual human-computer interface destruction of a message stored in the message data store that was previously selected for removal by presenting an animation selected from an animation data store on the visual human-computer interface, and the message management module causes one of deletion of the message from the message data store and archival of the message.

The animation rendering module can be configured to cause output of sound from a speaker of the electronic computing device when destruction of the message is graphically depicted. The message can be an electronically formatted message selected from the group of electronically formatted messages consisting of an electronic mail message, a short message service (SMS) message, and a multimedia messaging service (MMS) message. The animation can be an animation selected from the group consisting of a cartoon, a cartoon with accompanying sound, a computer-generated moving image, a computer-generated moving image with accompanying sound, a movie, and a movie with accompanying sound.

The apparatus can further comprise a security module that is in data communication with the message data store and configured to securely delete the message from the message data store. The apparatus can still further comprise a mobile communication and computing device that includes one or more non-volatile memory units configured to store and operating system, the message management module, the message data store, the animation rendering module, and the animation data store; a processor in data communication with each of the non-volatile memory units; a graphics processor in data communication with each of the non-volatile memory units; a touch-sensitive display screen in data communication with the command input/output module; a radio module including an antenna in data communication with at least one of the non-volatile memory units and the processor; a digital camera in data communication with at least one of the non-volatile memory units; a battery configured to provide electrical power to at least the processor, the touch-sensitive display screen, and the radio module; and a housing configured to hold together the processor, the graphics processor, the touch-sensitive display screen, the radio module, and the battery.

### DETAILED DESCRIPTION

The disclosed subject matter relates to apparatuses, articles of manufacture, and processes for creating and managing electronic messages, specifically including electronic mail, SMS, MMS, and other types of electronically formatted messages. The disclosed apparatuses articles of manufacture, and process can be implemented using standard programming or engineering techniques to produce software, firmware, hardware, or any combination of these to control a computing device to use the disclosed apparatuses and perform the disclosed processes.

The disclosed apparatuses and processes can be implemented without some of the disclosed specific details. In some examples, structures and devices are shown in block diagram form for ease of description. Additionally, although specific examples might use terminology that is consistent with a client/server network architecture or even be an example of a client/server implementation, those having an ordinary level of skill in this art area will recognize from reading this disclosure that the disclosed apparatuses and processes are not limited to a client/server architecture and can be adapted for use in other architectures, including peer-to-peer (P2P), mesh, and other suitable network architectures. Moreover, while a particular feature might be discussed only with reference to a specific example, that feature is not necessarily limited to use with that example and might be used in other contexts as needed or desired in a particular implementation.

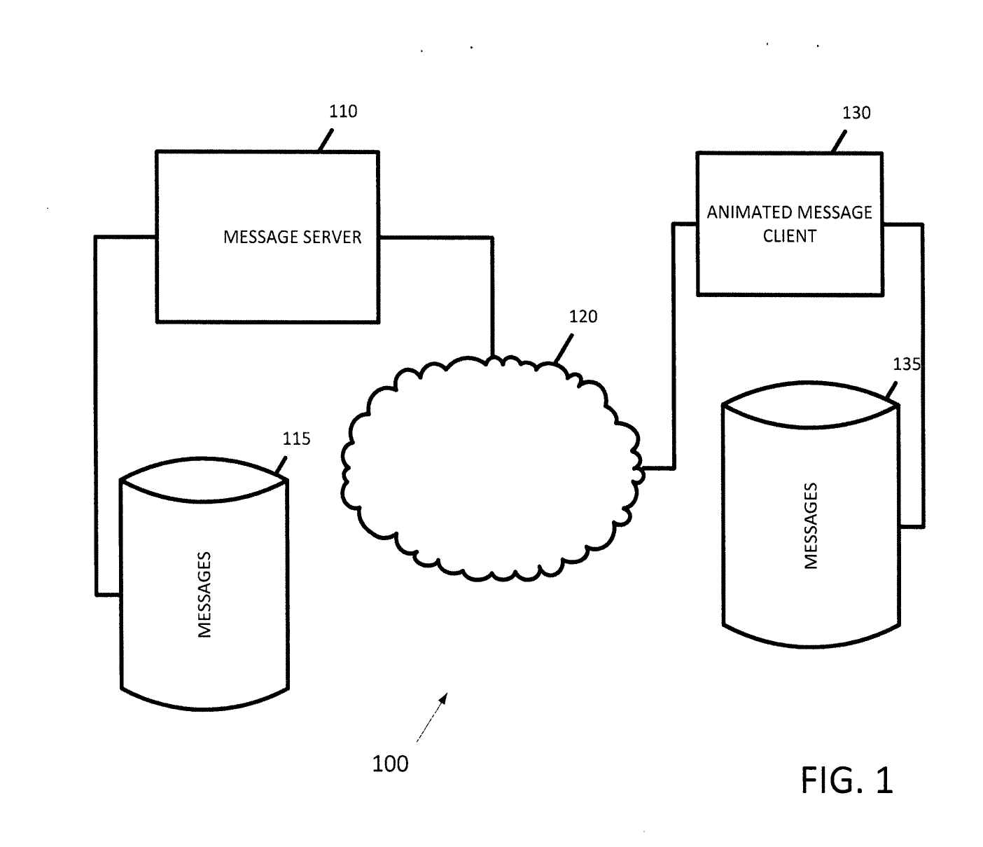

FIG. 1 is a system block diagram of an electronic messaging system 100. The electronic messaging system 100 can be used to distribute messages formatted in a defined electronic format. Among the formats that can be used are electronic mail, short message service (“SMS”) messages, multimedia message service (“MMS”) services, and any of a variety of other suitable message formats. For ease and simplicity of description, examples given to illustrate the structure and operation of various components of the electronic messaging system 100, as well as later examples with reference to other figures, will refer to electronic mail or email messages only. However, those having an ordinary level of skill in this art area will readily recognize from reading this disclosure how the exemplary apparatuses and processes described can be readily and easily adapted for use with other electronic message formats. Additionally or alternatively, integrated components that can use multiple message formats and communicate according to multiple protocols can be used as part of the electronic messaging system 100.

The electronic messaging system 100 can include a message server 110. The message server 110, when implemented as an email server, can operate using a number of defined protocols, including the simple mail transfer protocol (“SMTP”); a version of the post office protocol (“POP”), including version 3 of POP (“POP3”); and the Internet mail access protocol (“IMAP”); among other suitable protocols. As desired or required by a different implementation, especially when a different format of electronic message is used, the message server 110 can operate on a different suitable protocol. A server message store 115 can operate to provide persistent storage for one or more messages (not shown) for delivery to one or more users of the message server 110.

The message server 110 can connect to a network 120. The network 120 can be implemented as one of a variety of suitable network architectures with a wide variety of topologies and operating on a variety of different communication protocols, such as the transfer control protocol (“TCP”) and Internet Protocol (“IP”), often referenced together as TCP/IP. Specifically, the network 120 can be an internetwork, including the Internet, and can include wired and wireless components. Additionally or alternatively, the network 120 can be an intranetwork. The intranetwork can include both wired and wireless components.

An animated messaging client 130 can access the network 120. Specifically, the animated messaging client 130 can communicate with the messaging server 110 over the network 120 to retrieve one or more electronic messages, including email messages, intended for delivery to a user of the animated messaging client 130. A client message store 135 can operate to provide persistent storage for one or more users of the animated messaging client 130.

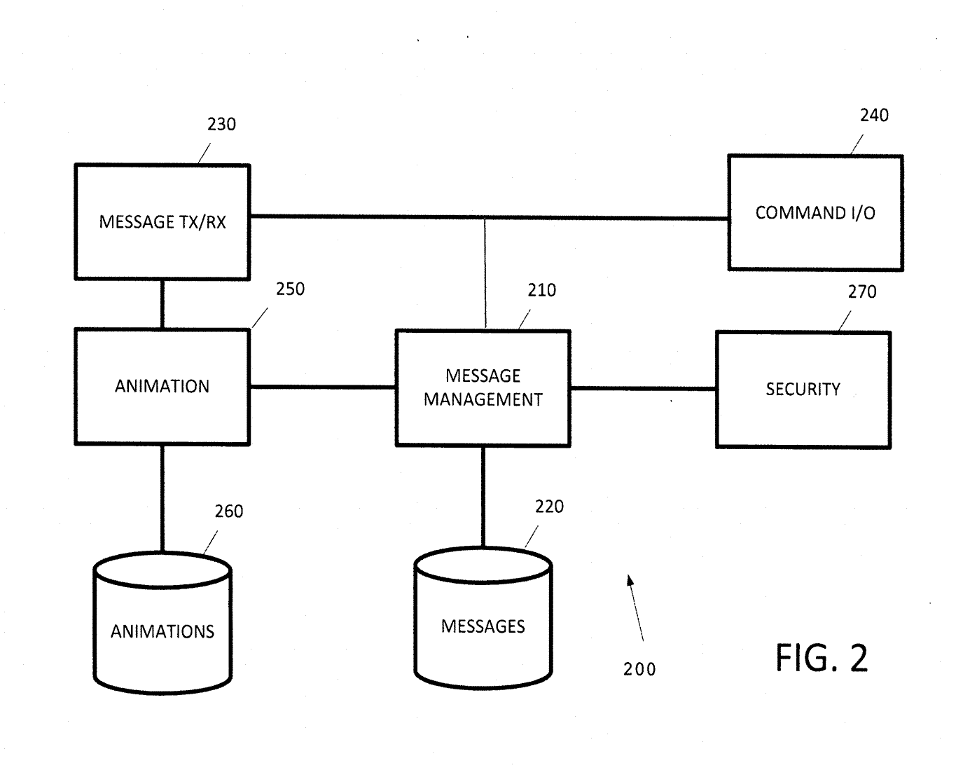

FIG. 2 is a system block diagram of an animated messaging client 200. the animated messaging client 200 can be used to implement the animated message client 130 and client message store 135 depicted and described above in conjunction with FIG. 1. Additionally or alternatively, the animated messaging client 200 can be used by one or more users to retrieve one or more electronically formatted messages, including email messages, from a messaging server, such as the message server 110 of FIG. 1.

A message management module 210 can perform tasks associated with management of a set of email messages stored in a message data store 220 and received through a message transceiver module 230. It should be noted that although the message transceiver module 230 is depicted in this example as a single unit, it can be implemented as a separate transmitter and receiver. Similarly, other components disclosed and described in this document can be separated or combined in any rational manner as needed or desired in a specific implementation to separate or combine functions or for another appropriate reason.

Specifically, the message management module 210 can cause the execution of a command input by a user through a human-computer interface (not shown) and detected by a command input/output module 240. Such commands can include, but are not limited to, commands to open, close, and delete email messages. In some implementations, the message management module 210 can cause low-level file operations such as opening and closing files to be performed by an operating system (not shown) by issuing appropriate commands or system calls to the operating system.

In response to a delete command received from the command input/output module 240, the message management module 210 can cause an animation module 250 to render an animation depicting destruction of a selected email message graphically, aurally or both graphically and aurally. Alternatively, the email message can be moved to an archive of email messages that can be stored in the message data store 220. For ease of description, references to deletion should be understood to be equally applicable to archiving operations.

As described in further detail below, the animation module 250 can render still or moving graphics and play associated sounds depicting destruction of an email message. The moving graphics can be rendered over an on-screen graphical depiction of the email message. A user can select an animation to be used by the animation module 250 when an email message is deleted. Additionally or alternatively, a user can choose to have the animation module 250 randomly choose an animation for use.

Graphics and sound information for rendering and play by the animation module 250 can be stored in an animation data store 260. The animation data store 260 can store animation information in a variety of file formats, including still image formats such as a joint photographic experts group (“JPEG”) file, a graphics interchange format (“GIF”) file, a portable network graphics (“PNG”) file, or another appropriate file format as needed or appropriate for a specific implementation. Moving graphics files formatted as moving pictures expert group (MPEG) files, Windows® Media (“WMV”) files, animated GIF files, moving JPEG files, Adobe® Flash® files, or other appropriate formats, with or without sound tracks, can also be stored in the animation data store 260. Additionally or alternatively, sound information can be stored as MPEG-1 or MPEG-2 Audio Layer III (“MP3”) files, Windows® Audio (“WAV”) files, Apple Audio Codec (“AAC”)-encoded files, or as files encoded in another appropriate format.

Content of each of the animations can be almost anything desired, including recorded live action, cartoons, and computer graphics effects, among others. These animations also can vary in length of time used to present the animation to a user. For example, a still graphic can illustrate flames to simulate the email message being burned or can illustrate a cracked glass or mirror reflection to simulate the email message being shattered. Moving graphics files can depict such scenes as a military fighter-style jet airplane firing missiles at the email message to destroy the message, or a machine gun shooting simulated bullet holes in the email message, among others. Sound effects such as explosions and gunshots can accompany these animations.

The message management module 210 can cause the security module 270 to securely delete the email message to attempt to make contents of that message unrecoverable. The security module can overwrite the contents of memory formerly reserved for the deleted email message with 0 or NULL values, with a random series of 1 or 0 values, or with a preselected arrangement of 1s and 0s, all in a series of one or more passes through the memory locations. Additionally or alternatively, a recognized algorithm, such as one described by in a Memorandum dealing with Disposition of Unclassified Computer Hard Drives by the Assistant Secretary of Defense, Command, Control, Communications, and Intelligence Division and dated Jun. 4, 2001, can be used.

The security module 270 can, additionally or alternatively, provide encryption and decryption capabilities to secure email messages while stored in the message data store 220. The security module 270 can be configured to support a variety of types of ciphers, including a private key cipher, a symmetric private key cipher, a public key cipher, and an elliptic curve cipher, among others. Specifically, the encryption module 160 can be configured to use the Advanced Encryption Standard (AES), the Data Encryption Standard (DES), triple DES (3DES), or another suitable cipher.

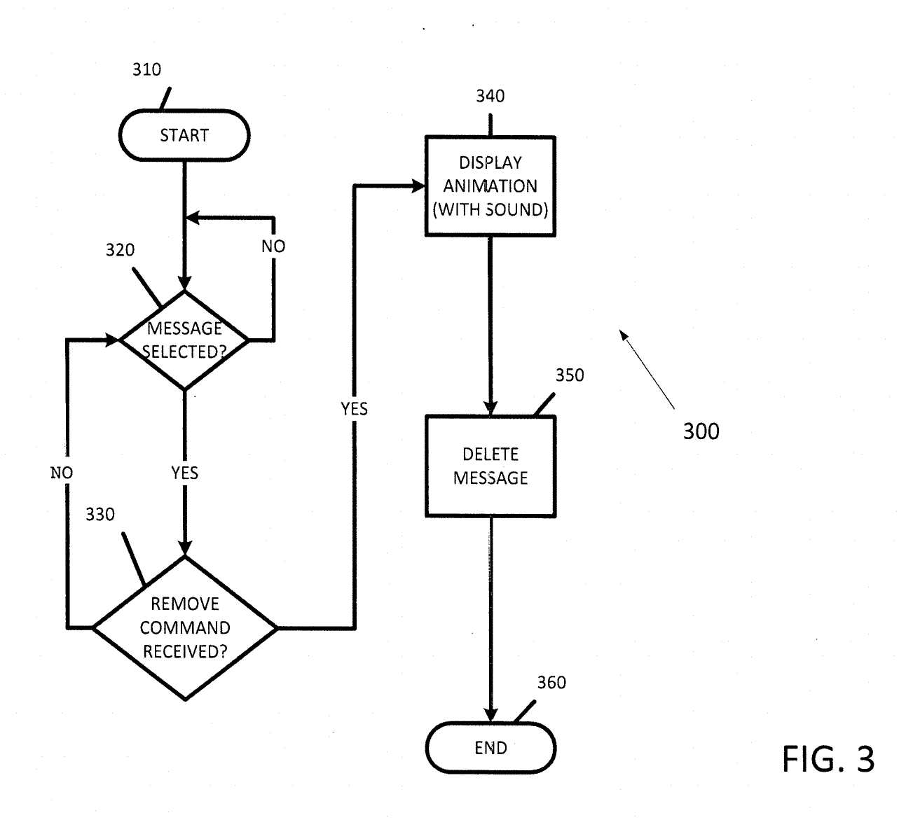

FIG. 3 is a flow diagram of a process 300 for animating deletion of electronic messages. Processing begins at START block 310 and proceeds to decision block 320. At decision block 320 a determination is made whether an email message has been selected by a user. Details of this determination can vary depending upon implementation details, but among the techniques that can be used are checking for a set data flag or passing of a message to a listener component.

If the determination made at decision block 320 is NO, processing remains at decision block 320. If the determination made at decision block 320 is YES, processing continues to decision block 330 where a determination is made whether a command has been received to delete a selected email message. If the determination made at decision block 330 is NO, processing returns to decision block 320. This processing flow can enable selection of more than one email message. If the determination made at decision block 330 is YES, processing continues to process block 340.

At process block 340, an animation depicting destruction of an email message is displayed on a visual user interface. This depiction can take the forms of displaying a still graphic with or without an accompanying sound over at least part of an area on screen originally used to display at least part of the email message to be deleted, or rendering an animation either with or without an accompanying sound over at least part of an area on screen originally used to display at least part of the email message to be deleted.

Processing continues to process block 350 where the previously selected message is deleted. It should be noted that this command can be applied to more than one email message in a batch or similar operation if more than one email message has been selected for deletion. As needed or desired in a particular implementation, deletion can be accomplished simply by marking storage areas as free space available to be used to store new data. Additionally or alternatively, secure deletion methods, including those previously described in conjunction with the security module 270 of FIG. 2, can be used. Processing concludes at END block 360.

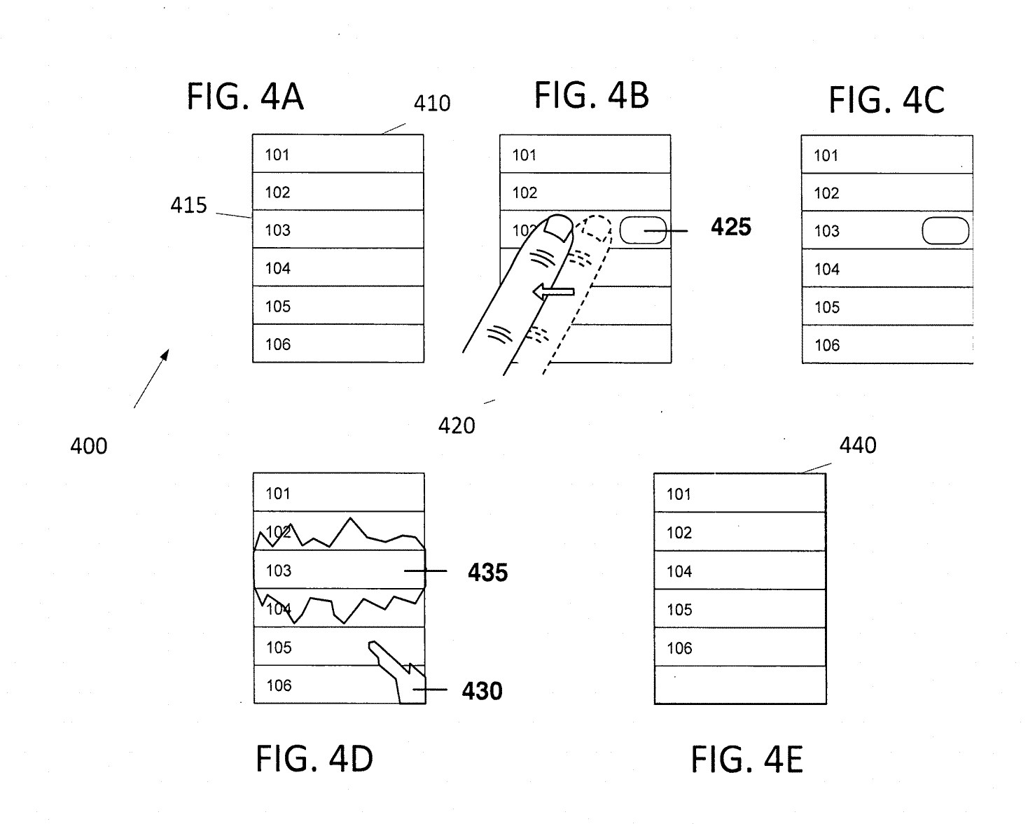

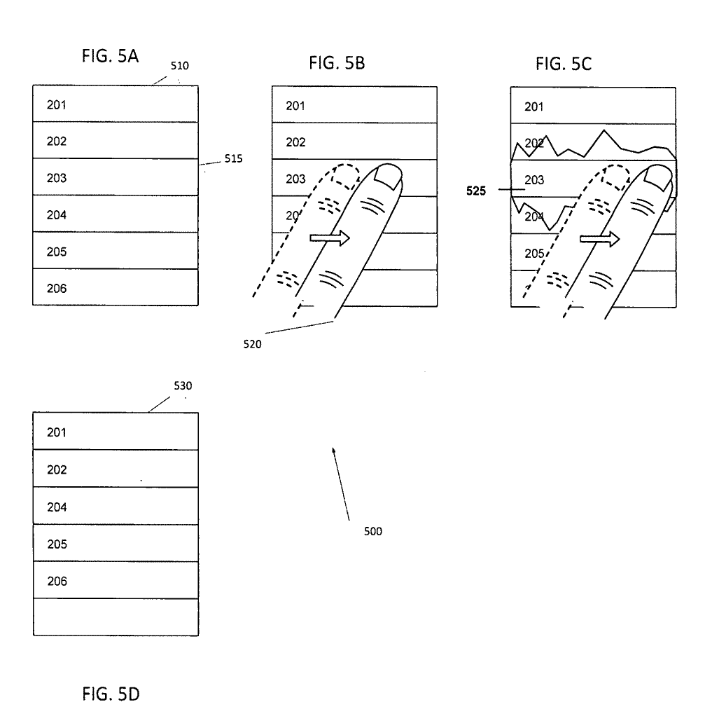

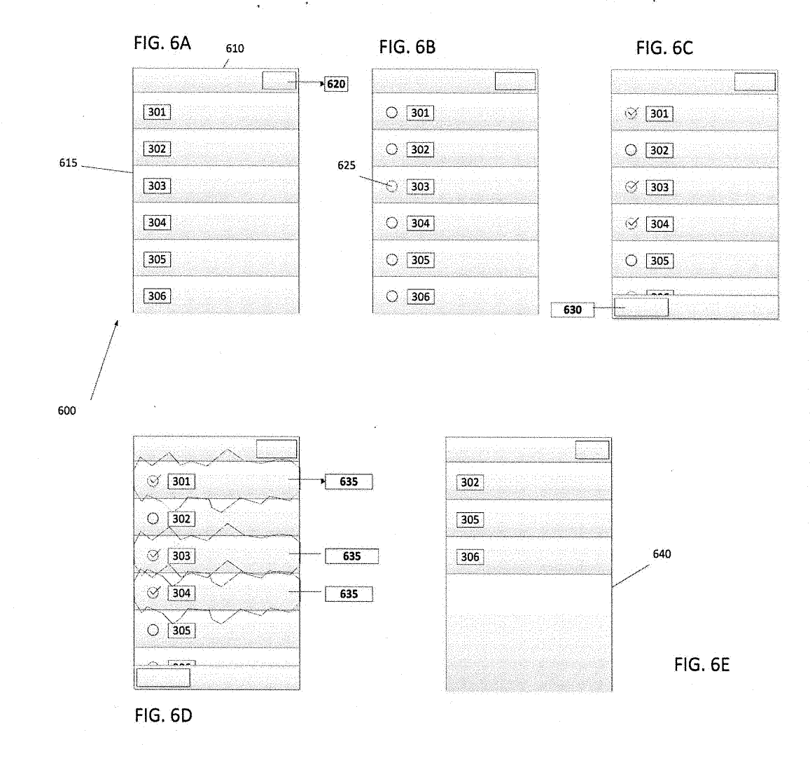

FIGS. 4A-4E are plan views of a user interface 400 for deletion of electronic messages. For ease and simplicity of description, the user interface 400 is shown as a list view of email messages displayed on a touch-sensitive screen of a mobile computing and communication device such as a smartphone, tablet computer, or laptop computer with a touchscreen. Those having an ordinary level of skill in this art area will readily recognize from reading this description that different data views, such as a threaded or hierarchical views, among others, can be used and that minor variations can be made to accommodate different command input techniques, such as use of a mouse with a personal computer and non-touch-sensitive display, among others. The same is true for FIGS. 5A-5D and FIGS. 6A-6E.

In FIGS. 4A-4E, a list 410 of email messages is shown. The list can include an email message 415. A finger 420 of a user can swipe across a surface of a touch-sensitive screen in a first direction, depicted here as moving from right to left from the perspective of the user, to select the email message 415 and activate a delete button 425. Following depression of the delete button 425, an animation beginning its display at initial region 430 and continuing its display in at least part of primary region 435 can be presented on-screen. This animation can show a fighter jet flying onto the screen at the initial region 430 and firing missiles to destroy the email message 415, with one or more explosions depicted in the primary region 435. At the conclusion of the animation, the email message 415 can be deleted and a modified list 440 of email messages can be presented to the user without the presence of the now-deleted email message 415.

FIGS. 5A-5D are plan views of a user interface 500 for quick deletion of electronic messages. In FIGS. 5A-5D, a list 510 of email messages is shown. The list can include an email message 515. A finger 520 of a user can swipe across a surface of a touch-sensitive screen in a first direction, depicted here as moving from left to right from the perspective of the user, to bother select the email message 515 and input a delete command. Following the finger swipe, an animation can be presented on-screen in at least part of region 525. To indicate that a quick delete function has been indicated, this animation can be shorter in duration than the animation described above in conjunction with FIGS. 4A-4E. This shorter animation can be of an explosion to destroy the email message 515. At the conclusion of the animation, the email message 515 is deleted and a modified list 530 of email messages can be presented to the user without the presence of the now-deleted email message 515.

FIGS. 6A-6E are plan views of a user interface 600 for batch deletion of multiple electronic messages. In FIGS. 6A-6E, a list 610 of email messages is shown. The list can include an email message 615. A multi-select activation button 620 can be pressed to activate a selection button 625 for each email message in the list 610. The selection button can be implemented as a radio button, a checkbox, or with another suitable on-screen selection device.

Each of the selection buttons 625 can be activated to indicate that an email message associated with the selection button 625 is to be deleted. A deletion command can be entered by pressing a delete button 630. Following depression of the delete button 630, one or more animations can be presented on-screen in at least part of each region 633. This animation can be one of the previously described animations or a different animation. At the conclusion of the animation, each previously selected email message can be deleted and a modified list 640 of email messages can be presented to the user without the presence of the now-deleted email messages.

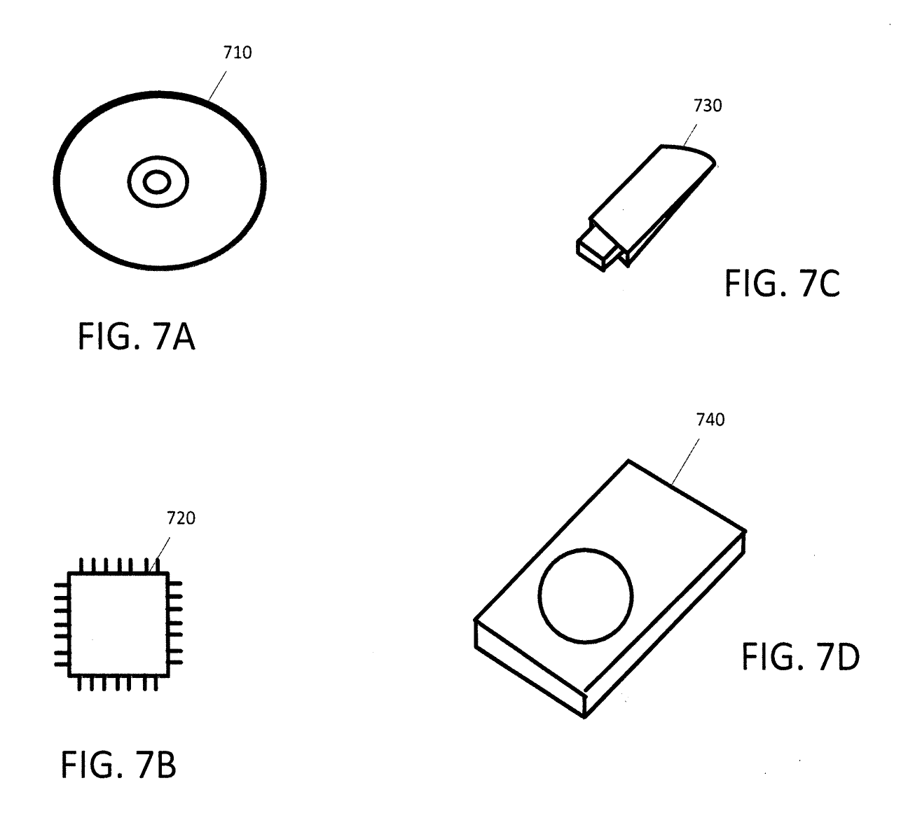

FIG. 7A is a plan view of an optical storage device 710. The optical storage device 700 can be a compact disk (“CD”), a digital versatile disk (“DVD”), or a Blu-Ray disk. Specifically, the optical storage device 700 can be used to preserve computer-readable and computer-executable instructions that can encode the software components and computer-implementable processes described above.

FIG 7B is a plan view of a non-volatile memory chip 720. The non-volatile memory chip 720 can be a memory chip such as a flash memory chip or an electrically erasable programmable memory (“EEPROM”) chip. Specifically, the non-volatile memory chip 720 can be used in a computing device to preserve computer-readable and computer-executable instructions that can encode the software components and computer-implementable processes described above.

FIG. 7C is a perspective view of a non-volatile storage device 730. The non-volatile memory chip 730 can be a memory chip such as a flash memory chip or an electrically erasable programmable memory (“EEPROM”) chip. Specifically, the non-volatile memory chip 730 can be used with a computing device to preserve computer-readable and computer-executable instructions that can encode the software components and computer-implementable processes described above during transport or transfer from one machine to another.

FIG. 7D is a perspective view of a hard disk drive 740. The hard disk drive 740 can include one or more magnetic platters or can be a solid-state hard drive. Specifically, the hard disk drive 740 can be used in a computing device to preserve computer-readable and computer-executable instructions that can encode the software components and computer-implementable processes described above.

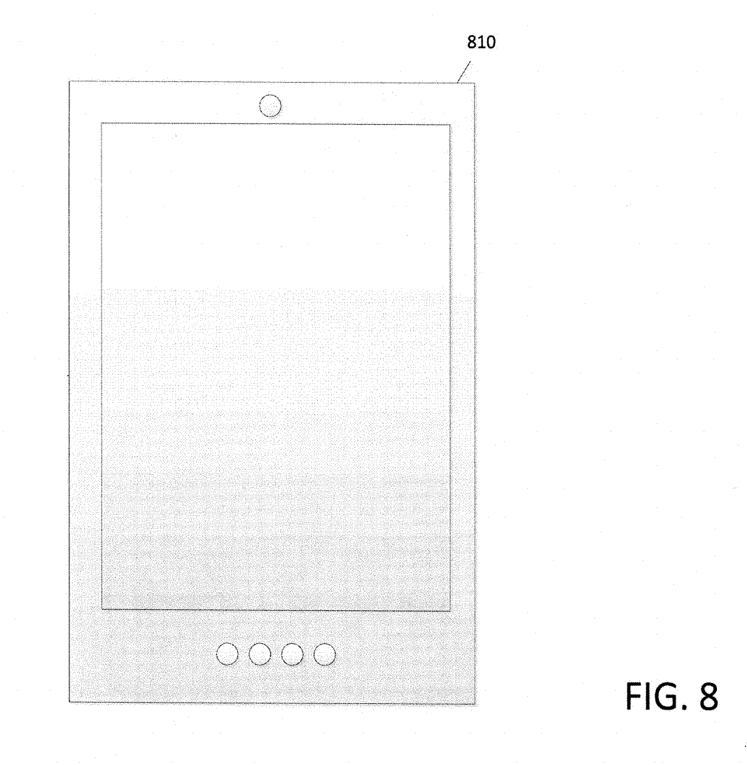

FIG. 8 is a plan view of a mobile communication and computing device 810. The mobile communication and computing device 810 can be a smartphone, a tablet computing device, a personal digital assistant, or similar device. The mobile communication and computing device 810 is shown as a smartphone. Alternatively, the mobile communication and computing device 810 can be implemented as a tablet computer, a laptop computer, a laptop computer with a touch-sensitive display, a personal digital assistant (“PDA”), or other appropriate device.

The mobile communication and computing device 810 can include one or more non-volatile memory units configured to store an operating system and software or firmware configured to store a message management module, a message data store, an animation rendering module, and an animation data store. The mobile communication and computing device 810 can also include a processor in data communication with each of the non-volatile memory units, a graphics processor in data communication with each of the non-volatile memory units, and a touch-sensitive display screen in data communication with the command input/output module.

Further, the mobile communication and computing device 810 can include a radio module including an antenna in data communication with at least one of the non-volatile memory units and the processor, a digital camera in data communication with at least one of the non-volatile memory units, a battery configured to provide electrical power to at least the processor, the touch-sensitive display screen, and the radio module, and a housing configured to hold together the processor, the graphics processor, the touch-sensitive display screen, the radio module, and the battery. Other components can be used as desired in a particular implementation. Some components, such as the camera, can be omitted.

We claim:

1. A method, comprising the steps of:
determining that at least one message of a set of electronically formatted messages previously received by and stored in a memory of an electronic computing device was selected for removal from the electronic computing device;
determining that a removal command associated with the message was input into the electronic computing device through a user interface of the electronic computing device;
graphically depicting destruction of the message by presenting a destruction animation on a visual human-computer interface; and
removing the message from the set of electronically formatted messages.

2. The method of claim 1, wherein the step of graphically depicting destruction of the message comprises the step of optionally playing sound through a speaker of the electronic computing device.

3. The method of claim 2, wherein the destruction animation is an animation selected from the group consisting of a cartoon, a cartoon with accompanying sound, a computer-generated moving image, a computer-generated moving image with accompanying sound, a movie, and a movie with accompanying sound.

4. The method of claim 3, wherein the electronic computing device is a mobile communication and computing device and the visual human-computer interface is a touch-sensitive display screen.

5. The method of claim 4, wherein the message is a message selected from the group consisting of an electronic mail message, a short message service (SMS) message, and a multimedia messaging service (MMS) message.

6. The method of claim 5, wherein the removal command is activated by one of a selection of a button on the touch-sensitive display screen and a gesture made on a surface of the touch-sensitive display screen.

7. The method of claim 6, wherein the removal command is an archive command and the step of removing the message from the set of electronically formatted messages comprises archiving the message.

8. The method of claim 6, wherein the removal command is a deletion command and the step of removing the message from the set of electronically formatted messages comprises the step of deleting the message.

9. The method of claim 8, wherein the step of deleting the message comprises the step of securely deleting the message to prevent recovery of the message.

10. The method of claim 8, further comprising the step of sending a second deletion command from the mobile communication and computing device to a message server to instruct the message server to delete a copy of the message stored on the message server.

11. The method of claim 10, wherein the second deletion command is formatted to instruct the message server to securely delete the copy of the message stored on the message server to prevent recovery of the copy of the message stored on the message server.

12. A non-volatile computer-readable medium including computer-interpretable instructions encoded to instruct an electronic computing device to perform steps in a method, comprising:
determining that at least one message of a set of electronically formatted messages previously received by and stored in a memory of an electronic computing device was selected for removal from the electronic computing device;
determining that a removal command associated with the message was input into the electronic computing device through a user interface of the electronic computing device;
graphically depicting destruction of the message by presenting a destruction animation on a visual human-computer interface; and
removing the message from the set of electronically formatted messages.

13. The non-volatile computer-readable medium of claim 12, wherein the step of graphically depicting destruction of the message comprises the step of optionally playing sound through a speaker of the electronic computing device.

14. The non-volatile computer-readable medium of claim 13, wherein the destruction animation is an animation selected from the group consisting of a cartoon, a cartoon with accompanying sound, a computer-generated moving image, a computer-generated moving image with accompanying sound, a movie, and a movie with accompanying sound.

15. The non-volatile computer-readable medium of claim 14, wherein the electronic computing device is a mobile communication and computing device and the visual human-computer interface is a touch-sensitive display screen.

16. The non-volatile computer-readable medium of claim 15, wherein the message is a message selected from the group consisting of an electronic mail message, a short message service (SMS) message, and a multimedia messaging service (MMS) message.

17. The non-volatile computer-readable medium of claim 16, wherein the removal command is activated by one of a selection of a button on the touch-sensitive display screen and a gesture made on a surface of the touch-sensitive display screen.

18. The non-volatile computer-readable medium of claim 17, wherein the removal command is an archive command and the step of removing the message from the set of electronically formatted messages comprises archiving the message.

19. The non-volatile computer-readable medium of claim 18, wherein the removal command is an deletion command and the step of removing the message from the set of electronically formatted messages comprises the step of deleting the message.

20. The non-volatile computer-readable medium of claim 19, wherein the step of deleting the message comprises the step of securely deleting the message to prevent recovery of the message.

21. The non-volatile computer-readable medium of claim 19, further comprising the step of sending a second deletion command from the mobile communication and computing device to a message server to instruct the message server to delete a copy of the message stored on the message server.

22. The non-volatile computer-readable medium of claim 21, wherein the second deletion command is formatted to instruct the message server to securely delete the copy of the message stored on the message server to prevent recovery of the copy of the message stored on the message server.

23. An apparatus, comprising:
a message management module in data communication with a message data store of an electronic computing device that is capable of receiving an electronic message;
an animation rendering module in data communication with an animation data store of the electronic computing device; and
a command input/output module in data communication with the message management module and the animation rendering module, and configured to accept a removal command signal input through a user interface of the electronic computing device;
wherein, in response to a removal command signal,
the animation rendering module graphically depicts on a visual human-computer interface destruction of a message stored in the message data store that was previously selected for removal by presenting an animation selected from an animation data store on the visual human-computer interface, and
the message management module causes one of deletion of the message from the message data store and archival of the message.

24. The apparatus of claim 23, wherein the animation rendering module is configured to cause output of sound from a speaker of the electronic computing device when destruction of the message is graphically depicted.

25. The apparatus of claim 24, wherein the message is an electronically formatted message selected from the group of electronically formatted messages consisting of an electronic mail message, a short message service (SMS) message, and a multimedia messaging service (MMS) message.

26. The apparatus of claim 25, wherein the animation is an animation selected from the group consisting of a cartoon, a cartoon with accompanying sound, a computer-generated moving image, a computer-generated moving image with accompanying sound, a movie, and a movie with accompanying sound.

27. The apparatus of claim 25, further comprising a security module in data communication with the message data store and configured to securely delete the message from the message data store.

28. The apparatus of claim 25, further comprising a mobile communication and computing device that includes:
one or more non-volatile memory units configured to store an operating system, the message management module, the message data store, the animation rendering module, and the animation data store;
a processor in data communication with each of the non-volatile memory units;
a graphics processor in data communication with each of the non-volatile memory units;
a touch-sensitive display screen in data communication with the command input/output module;
a radio module including an antenna in data communication with at least one of the non-volatile memory units and the processor;
a digital camera in data communication with at least one of the non-volatile memory units;
a battery configured to provide electrical power to at least the processor, the touch-sensitive display screen, and the radio module; and
a housing configured to hold together the processor, the graphics processor, the touch-sensitive display screen, the radio module, and the battery.
